(19) United States
(12) Patent Application Publication
(10) Pub. No.: US 2004/0030731 A1
(43) Pub. Date: Feb. 12, 2004

(54) System and method for accessing files in a network

(76) Inventors: Liviu Iftode, Princeton, NJ (US); Suresh Gopalakrishnan, Somerset, NJ (US); Ashok Arumugam, Highland Park, NJ (US); Robert Sidie, Lebanon, NJ (US)

Correspondence Address: LAW OFFICE OF JOHN LIGON, 505 HIGHLAND AVENUE, P.O. BOX 43485, UPPER MONTCLAIR, NJ, 07043, US

(21) Appl. No.: 10/406,533

(22) Filed: Apr. 3, 2003

Related U.S. Application Data
(60) Provisional application No. 60/369,313, filed on Apr. 3, 2002.
(60) Provisional application No. 60/369,587, filed on Apr. 4, 2002.

(51) Int. Cl. G06F 17/30

(52) U.S. Cl. 707/205

(57) ABSTRACT

A distributed file system architecture, characterized as a Federated File System (FedFS), is provided as a loose clustering of local file systems existing in a plurality of cluster nodes. The distributed file system architecture is established as an ad-hoc global file space to be used by a distributed application and a separate FedFS process is created for each application. Correspondingly, the lifetime of a FedFS process is limited to the lifetime of the distributed application for which it was created. File access for files in the node cluster is provided in a location-independent manner. FedFS also supports dynamic reconfiguration, file migration and file replication. FedFS further operates on top of, and without constraint on autonomous local file systems.

### RELATED APPLICATION

The invention is related to U.S. Provisional Application No. 60/369,313, filed on Apr. 3, 2002, entitled “Federated Filesystems Over The Internet,” and to U.S. Provisional Application No. 60/369,587, filed on Apr. 4, 2002, entitled “Federated Filesystems Over The Internet,” the subject matter of all such provisional applications being fully incorporated by reference herein.

### FIELD OF THE INVENTION

This invention relates to systems for identifying and accessing files stored on a plurality of distributed nodes.

### BACKGROUND OF THE INVENTION

The rapid expansion of electronic data gathering in recent years is also driving increasing demand for better performance and availability in storage systems. In addition, as the amount of available storage becomes larger, and the access patterns more dynamic and diverse, the maintenance properties of the storage system have become as important as performance and availability. Advances in the organization of file systems play a crucial role in the ability to create a diverse array of distributed applications.

For example, a significant portion of current day Internet services are based on distributed applications and cluster-based servers. In these applications, all nodes in the cluster need to have access the same storage medium. Hence, the performance of the service relies on the performance of the underlying storage system.

Current distributed file systems that are intended to provide a cluster wide global view of the storage medium are characterized by various shortcomings. In general, such current systems either fail to provide location independent file naming (e.g., Network File System (NFS)), or the file naming is tightly coupled into the block level storage (e.g., AFS, originally, Andrew File System), which makes it difficult to aggregate heterogeneous systems.

### SUMMARY OF THE INVENTION

A distributed file system architecture, characterized as a Federated File System (FedFS), is provided as a loose clustering of local file systems existing in a plurality of cluster nodes. The new distributed file system architecture is established as an ad-hoc global file space to be used by a distributed application and a separate FedFS process is created for each application. Correspondingly, the lifetime of a FedFS process is limited to the lifetime of the distributed application for which it was created.

With FedFS, the application can access files in the cluster in a location-independent manner. FedFS also supports dynamic reconfiguration, file migration and file replication. All of these features are provided by FedFS on top of autonomous local file systems—i.e., the local file systems are not changed in order to participate in the federation, and no federation specific metadata is stored in the local file systems.

Additionally, by providing a distributed application with access to files of multiple local file systems across a cluster through a location-independent file naming, FedFS is able to implement load balancing, migration and replication for increased availability and performance.

FedFS uses a low-overhead, user-level communication mechanism called remote memory communication (RMC) to achieve high performance.

### BRIEF DESCRIPTION OF THE DRAWINGS

FIG. 1 schematically depicts a Federated File System according to the invention configuration on a four node cluster.

FIG. 2 illustrates a virtual directory created according to the method of the invention.

FIG. 3 depicts virtual directories and directory tables created according to the method of the invention.

FIG. 4 provides a schematic depiction of the look-up function of the invention.

FIG. 5 shows a plot of average operation latency against load for a test of the method of the invention vs. a prior art method.

### DETAILED DESCRIPTION OF THE INVENTION

A new file system is described herein that provides a global file space for a distributed application by aggregating in a loose federation the local file systems of a cluster of nodes serving the distributed application. The inventors have designated this new file system as a Federated File System, which is generally referred to herein by the acronym “FedFS.”

The FedFS system provides the application with access to files in the cluster of nodes in a location-independent manner. Moreover, FedFS operates on top of autonomous local file systems—i.e., the local file systems are not changed in order to participate in a FedFS federation, and no federation specific metadata is stored in the local file system. To achieve such local system autonomy, FedFS input/output (I/O) operations translate into local file system operations and the global file space metadata becomes soft state that can be stored in volatile memory of the cluster nodes. As a result, a local file system can join or leave a federation anytime, without requiring any preparation, and without carrying out persistent global state operations.

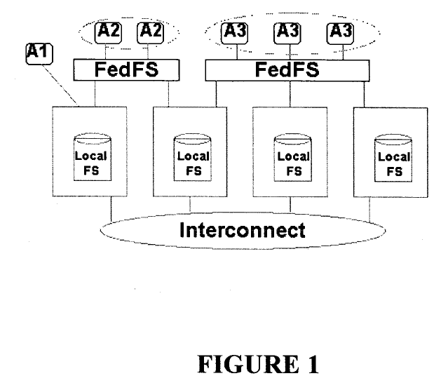

FIG. 1 provides a schematic depiction of an exemplary set of FedFS processes operating in respect to a four-node cluster. As noted in the Summary, a FedFS process is created ad-hoc by each application, and its lifetime is limited to the lifetime of the distributed application. In the figure, three different applications, A1, A2 and A3, are shown running on the exemplary cluster. Application A2 is distributed across nodes 1 and 2, and uses FedFS1 to merge the local file systems of these nodes into a single global file space. Similarly, application A3 is distributed across nodes 2, 3 and 4 and uses FedFS2. Application A1 runs only on node 1 and accesses the local file system directly. Notes that, for this illustrative configuration, the local file system of node 2 is part of two FedFS processes.

FedFS leverages user-level remote memory communication (RMC) in the cluster for data transport as well as for implementing coherence protocols efficiently. RMC allows data to be written directly into a remote node's memory without any communication related processing overhead on the remote node (i.e., non-intrusive and zero-overhead). This also eliminates extra data copying that is typically involved in traditional communication mechanisms (thus enabling zero-copy data transfer). The RDMA-write (Remote Direct Memory Access) feature is used by FedFS to transfer file data blocks. The non-intrusive nature of RDMA writes is particularly useful in implementing various coherence protocols (especially invalidation based ones) that FedFS supports. For such protocols, rather than exchanging messages to read or modify bit values and metadata, RMC allows the operations to be performed as read/write operations on local memory (onto which the remote memory has been mapped). It is noted that Virtual Interface Architecture (VIA) and Infiniband Architecture are two recent communication standards that support the RMC model, and therefore can be used to implement FedFS.

In the following sections, the architecture and operation for the Federated File System of the invention are described in detail.

I. Federated File System Architecture

A federated file system is a distributed file system built on top of local file systems that retain local autonomy. In a FedFS process, local file systems can simultaneously function as stand-alone file systems or as part of FedFS. In FedFS, the file system functionality is split between the federal layer (“FL”) and the local layer (“LL”). The LL is responsible for performing the file I/O operations on the local files as directed by the FL. With FedFS, any local file system can be used as the local layer. The FL in FedFS is responsible for global file naming and file lookup, as well as supporting global operations such as load balancing, replication, coherence and migration.

A. Virtual Directories

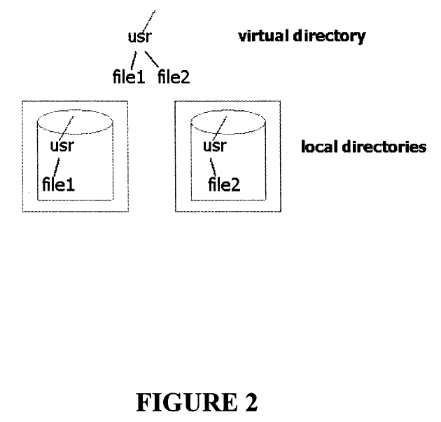

FedFS aggregates the local file systems by merging the local directory tree into a single global file tree. A virtual directory (“VD”) in FedFS represents the union of all the local directories from the participating nodes with the same pathname. For instance, if a directory “/usr” exists in each local file system, the virtual directory “/usr” of the resulting FedFS will contain the union of all the “/usr” directories. An exemplary FedFS virtual directory, created by merging the two local file systems, is illustrated in FIG. 2.

A particular advantage of the FedFS file aggregation strategy is location-independent naming. Because the virtual directory is the union of the local directories with the same pathname, the pathname of a FedFS file indicates the virtual directory, but does not provide any information about where it is located. Therefore, in FedFS, files can naturally migrate from one node (local directory) to another without changing the path-name in the FedFS virtual directory.

To allow file migration without requiring virtual directory modification, each pathname (virtual directory or file) is associated with a manager. The nodes where the corresponding pathnames are present in the local file system are characterized here as homes. The manager for a given pathname will be determined by applying a consistent hash function to the pathname. The manager is responsible for keeping the home information for a file with which it is associated.

The content of a virtual directory is determined on demand—i.e., whenever it is necessary for FedFS to solve a lookup—by performing a directory merging or dirmerge operation. Preferably, the virtual directory content calculated by a dirmerge is cached in volatile memory of the manager, in order to avoid repeated dirmerge operations over multiple accesses by the application of the determined virtual directory. The manager may, however, discard a VD if it runs low in memory, in which case the content of the VD will be regenerated by another dirmerge when the next access occurs.

Ultimately, the manager is responsible for the VD content which can be either cached or calculated using the dirmerge operation.

B. Dirmerge and Directory Tree Summaries

As indicated above, the dirmerge operation is initiated by the pathname manager to determine the content of a virtual directory. To perform a dirmerge, the manager will send a readdir request to all the nodes of the cluster that may have that directory in their local file systems. [readdir is a known system call in the art and is used herein to denote a request for directory contents.] As will be apparent, dirmerge is not a scalable operation, but it is expected to be performed infrequently.

In a preferred embodiment of the invention, each node in a cluster will generate a summary of its directory tree and pass it to every other node in the cluster when the cluster is first established or when the node joins the cluster. For the preferred embodiment, the directory tree summary will be determined using Bloom filters, a well known means for creating a compact representation of locally stored files. The summary so determined will include only the directory tree without the files. [The inventors have determined empirically that the performance of Bloom filters improves with number of hash functions and the number of bits in the summary.]

When a dirmerge is found to be required, the manager will use the directory tree summaries to determine which nodes may have that directory in their local file systems and direct the readdir request only to those nodes. Since Bloom filters are known to generate only false positives, dirmerge is guaranteed not to miss any node which has the directory.

Updating the directory tree summary is a resource intensive operation but the operation can be scheduled on a relatively infrequent basis. For example, such update frequency may be made a function of the occurrence of a given number of changes to the local directory tree. Note that, whenever a new directory is created, only the summary of the manager of the corresponding virtual directory must be updated. Therefore, instead of recalculating the summary and sending it to every other node, a simple update to the manager of the newly created directory suffices. While directory deletions may be addressed in a corresponding manner, it should be understood that a policy of ignoring directory deletions will only create additional false positives in the Bloom filters.

C. Directory Table

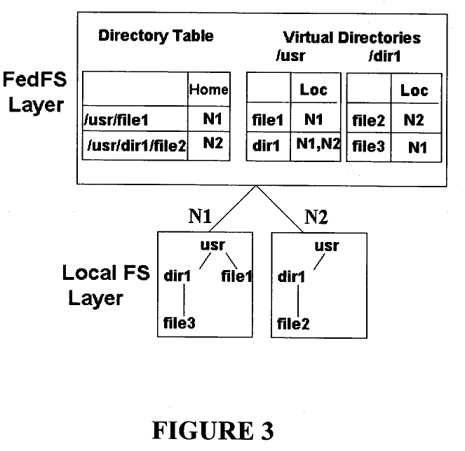

Under the basic FedFS architecture, file lookup always requires an extra access to the file manager to determine the home of the file. In a further embodiment of the invention, a directory table (DT) is added to each node which will act as a cache of virtual directory entries for the most recent file lookup accesses This added directory table will eliminate this extra FedFS access step in the normal case. This further embodiment is schematically illustrated in FIG. 3.

In the DT, an entry must contain the full pathname of the file and not just the local name as it is stored in the virtual directories. The access to the directory table will be performed using a hash on the full path-name. However, the open file table may contain an index in the directory table of the local node or directly to the home node of the open file to avoid hash function calculation on each file access.

II. Federal Layer Operations

In this section, the operations performed by the federal layer are described, namely file lookups, file migration and replication and dynamic reconfiguration.

A. File Lookup Operation

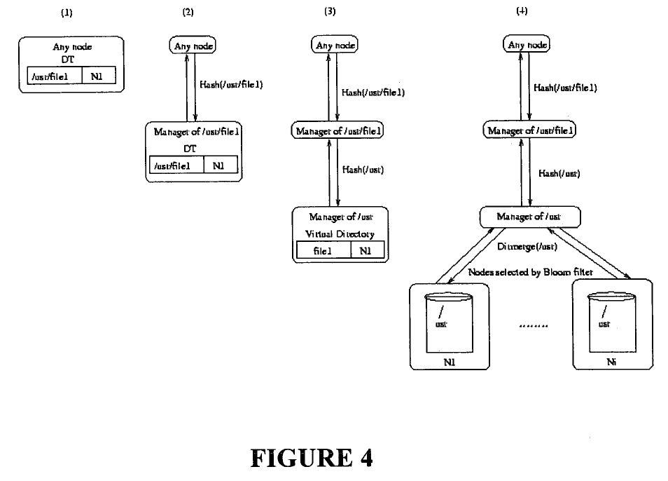

The lookup operation is performed to locate a file i.e. determine the home for the file from its pathname. FIG. 4 illustrates the four possible paths a lookup operation can take. In the normal case, the lookup operation is carried out in the order shown in the figure, and as described below:

1. Any node: a node performing a lookup will first search its local directory table for a previously cached entry. If there is a hit in the DT (which is likely if file accesses exhibit good temporal locality), the lookup completes at the local node.

2. If there is a miss in the local DT, the lookup operation will contact the manager of the file. The manager is determined by a hash on the pathname. The manager refers to its DT to find the home of the file and if found, the lookup terminates.

3. If there is a miss in the file manager's directory table, the lookup operation contacts the manager of the file's parent directory. The parent directory is easily obtained from the pathname and the parent's manager is located by using the hash function. If the manager of the parent has the virtual directory cached, the lookup completes and the home of the file is returned.

4. Finally, if the virtual directory is not cached at the parent directory manager, the parent directory calls for a dirmerge operation to construct the virtual directory. As explained in the previous section, Bloom filters are used and contact is only made to the subset of the nodes that are likely to have that directory in the local file system.

Lookup operations will be fast in the common case. Although the resource cost of querying the file's manager, querying the parent's manager and doing a dirmerge at the parent's manager may be significant, it should be understood that those are normally one time costs, easily amortized over multiple lookups.

B. Other File Operations:

Create: In order to create a file or directory, a server node first queries the manager to find the home, and then contacts the home. The home node sends an “add_entry” request to update the virtual directory at the manager of the parent directory, and creates the file if it doesn't exist already. The home node, which is the physical location of a file, is decided at the time of creation by the manager of the file. Various policies could be used to place the requested file.

Delete: A lookup is performed to identify the home of the file and the delete request is forwarded to the home node. The home node deletes the file and sends a “del_entry” request to update the virtual directory at the manager of the parent directory.

Open: A lookup is performed to identify the home of the file and an open request is sent to the home node. The home node opens the file, updates the directory table entry for the file and returns a dummy descriptor.

Close: The close request is sent to the home of the file. The home node closes the file and updates the directory table entry for the file.

Read/write: The first access to any data block of a file has to be handled by the home node where the file resides physically. FedFS caches data blocks of files located in other server nodes in the cluster, thus optimizing subsequent accesses to the cached data blocks. The blocks are cached at the time of first access and an LRU replacement policy is used for this data block cache. Writes are performed synchronously using a write-through mechanism.

C. File Migration and Replication

File migration and replication are enabled by the location independent file naming of the invention, and by using the virtual directory architecture and additional level of indirection involving managers in the lookup path.

Whenever the migration policy decides to move a file, the file is scheduled to be pulled by the target node. After migration, the file's manager and parent's manager are updated. This mechanism ensures that migrating a file does not disrupt service of that file. When the home of a file changes due to migration, some of the cached DT entries in other nodes become stale. They are not necessarily invalidated; rather the nodes use the stale information and discover that the file is no longer present. Then, the manager is queried again to find the new home. While this passive mechanism presents additional overhead if a lookup happens on a file that was deleted, this is not a common case. Of course, an active step of deletion for a removed file at a node may also be pursued, but at an expected higher resource utilization cost.

In a further embodiment of the invention, a replication policy is followed wherein two coherent replicas (primary and secondary) are maintained for each file. On a lookup, the manager returns the primary node as the home of the file. If the primary replica becomes unavailable, the manager can redirect subsequent lookups to the secondary. When one of the copies becomes unavailable (e.g., a node leaves or crashes), the manager create another copy.

D. Dynamic Reconfiguration

In FedFS, nodes can join the federation to increase the file set and storage, and may, as well, leave the federation. When a node joins FedFS, manager responsibilities for some files and directories are transferred to it. The hashing mechanism to locate managers is able to accommodate this change, because the FedFS process incorporates the number of nodes in the hash function. The new node will also send its summary information to all the nodes. When a file lookup occurs at the new node, the query will reach the manager of the parent. If a new node summary arrives after the last dirmerge, the parent manager will perform incremental dirmerge involving only the new node, and the file becomes visible as part of the global space.

When a node leaves the federation, the files and directories for which this node was the manager are handed off to other nodes. Files for which the leaving node was one of the consistent replica locations would then be replicated on another node.

III. FedFS Implementation

A prototype implementation of the FedFS has been built by the inventors as a user level library in Linux that exports the standard file system interface. With that implementation, the FedFS communication library is built using VIA and the Bloom directory tree summaries (4 Kb per node) are generated using 4 hash functions.

The prototype FedFS implementation was applied with a user level NFS server (NFSv2) on Linux. As is known, an NFS server can serve only local files, below the exported mount point. An NFS server linked with FedFS, characterized herein as Distributed NFS, or DNFS, can distribute its files on all the nodes in the cluster, and serve them out of any of the nodes. The file placement policy used for this implementation was to collocate a file or directory with its manager.

The experiments were performed in a cluster of 8 Pentium II 300MHz dual-processors., each with 512 KB cache, 512 MB memory and 2 SCSI disks each (one 3.6 GB IBM disk and one 8.3 GB Quantum disk) and running Linux 2.2.14 kernel (smp version). Each node incorporated an SMC Epic100 Ethernet card and a Giganet VIA card used only for intra-cluster communication. Client-server communication was carried out using the Ethernet, and server-server communication used the Giganet. The cache maintained at each server was 128 MB.

From this experimental implementation, the following observations are made. The cost for remote operations has three components. First is the latency due to network communication. On a Gigabit network, this latency is of the order of tens of microseconds. Second is the queuing delay in the remote node. To avoid serializing parallel requests, request messages are first queued by a network polling thread and then picked up by the protocol thread. The network and queuing delay for a message exchange is roughly 200 Ms. The final component is the operation latency at the remote node.

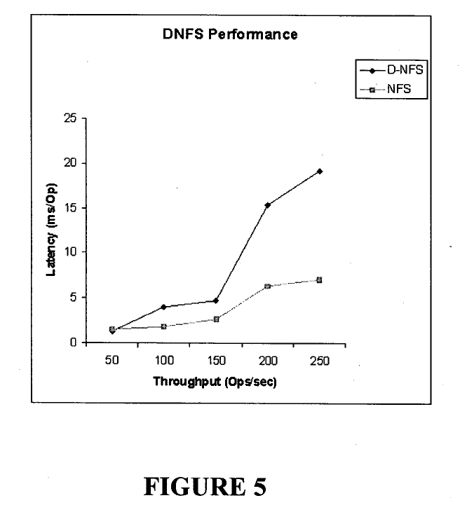

The inventors also compared the performance of a Distributed NFS (DNFS=NFS+FedFS) implementation against a standard NFS arrangement. The NFS application is set up with a single node running the regular NFS server and four clients mounting a single volume from the server. With the DNFS, the clients mounted the same volume from four different servers, while accessing the same file set. FIG. 5 shows a plot of average operation latency against load offered by the clients for the NFS and DNFS applications. As will be seen from the figure, the DNFS (FedFS) application scales better than regular NFS. This is, of course, the expected result since the same load is now spread across multiple servers while serving the same file set.

Note that FedFS scales with respect to server configurations also. Adding more nodes to FedFS only increases the aggregate storage and bandwidth it can deliver, without additional communication costs. This occurs because almost all FedFS operations involve communication between two nodes—a requesting node and the home or the manager. The only operation that involves more than three nodes use the dirmerge operation, which is performed only once per directory in the entire FedFS run-time.

A Federated File System architecture according to the invention provides multiple advantages over other distributed file systems solutions, including:

1) flexibility, by allowing the application to define its own file clustering territory at the run time;

2) easy to use global file naming, by merging the local file systems into a single global directory tree;

3) leverage of local file system performance optimizations;

4) faster development by using local file systems; and

5) use of Remote Memory Communication for high performance.

Numerous modifications and alternative embodiments of the invention will be apparent to those skilled in the art in view of the foregoing description. In particular, with the advent of new technologies, like VI/IP and Infiniband, the FedFS model may be extended over the wide area network, to provide a wide area storage aggregation solution, including wide area storage aggregation using the Direct Access File System (DAFS) architecture as the underlying component, and such an application is intended to be within the contemplation of the invention.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention and the exclusive use of all modifications which come within the scope of the appended claims is reserved.

What is claimed is:

1. A distributed file system provided in a global file space to access local file systems established in a plurality of clustered nodes.

2. The distributed file system of claim 1 wherein a new file access process is established ad hoc for ones of applications served by the system.

3. The distributed file system of claim 1 wherein file pathnames in the global file space are independent of a location of a file designated by the pathname on ones of the clustered nodes.

4. The distributed file system of claim 1 wherein no change is required in a local file system for participation in the global file space file access process.

5. The distributed file system of claim 1 wherein virtual directories are created in the global file space as a union of local directories from participating nodes with the same pathname.

6. The distributed file system of claim 3 wherein the global pathnames are stored and maintained in volatile memory.

7. The distributed file system of claim 5 wherein the virtual directories are stored and maintained in volatile memory.

8. The distributed file system of claim 5 wherein a directory table is provided at ones of the nodes to store virtual directory entries for recent file accesses.

9. The distributed file system of claim 1 wherein directory tree summaries are generated for ones of the nodes in the node cluster.

10. The distributed file system of claim 9 wherein generation of the directory tree summaries is carried out using a Bloom filter.

11. The distributed file system of claim 1 further including the step of utilizing low-latency user level communication protocols.

12. A system for providing access from a global file space to local files distributed across a cluster of local nodes comprising:
creating separate instances of the file system for ones of applications served by the system; and
establishing, for each application, a virtual directory in the global file space as a merger of local file directory trees for participating nodes in the node cluster.

13. The file access system of claim 12 wherein a pathname in the virtual directory represents the union of local file directories from participating nodes with the same pathname.

14. The file access system of claim 12 wherein file pathnames in the global file space are independent of a location of a file designated by the pathname on ones of the clustered nodes.

15. The file access system of claim 12 wherein the virtual directories are stored and maintained in volatile memory.

16. The file access system of claim 12 wherein global pathnames are stored and maintained in volatile memory.

17. The file access system of claim 12 further comprising a directory table provided at ones of the nodes to store virtual directory entries for recent file accesses.

18. The file access system of claim 12 further comprising a generation of directory tree summaries for ones of the nodes in the node cluster.

19. The file access system of claim 18 wherein generation of the directory tree summaries is carried out using a Bloom filter.

20. The file access system of claim 12 further comprising low-latency user level communication protocols.
